(19) United States
(12) Patent Application Publication
(10) Pub. No.: US 2008/0219289 A1
(43) Pub. Date: Sep. 11, 2008

(54) 10GBase-T link speed arbitration for 30m transceivers

(76) Inventors: William Lee Harrison, El Dorado Hills, CA (US); Stephen M. McConnell, Folsom, CA (US)

Correspondence Address: LUMEN PATENT FIRM, INC., 2345 YALE STREET, SECOND FLOOR, PALO ALTO, CA, 94306, US

(21) Appl. No.: 11/985,330

(22) Filed: Nov. 13, 2007

Related U.S. Application Data
(60) Provisional application No. 60/859,409, filed on Nov. 15, 2006.

(51) Int. Cl. H04L 29/04

(52) U.S. Cl. 370/465

(57) ABSTRACT

A method of power management in a 10GBase-T Ethernet transceiver is provided. The 10GBase-T Ethernet transceiver is according to an IEEE 802.3an standard. The method includes determining a cable length from a transmitter to a receiver in the Ethernet. A low-power mode of the transceiver is enabled when the cable length is determined to be 30-meters or less, and the low-power mode of the transceiver is disabled when the cable length is determined to be greater than 30-meters. The cable length determination can be accomplished using time domain reflectometry prior to an auto-negotiation process, during the auto-negotiation process, or through interrogation of a management interface. The transceiver can be monitored, where an operational link speed is reduced when transmit and receive data is below a predetermined level for a predetermined duration.

### FIELD OF THE INVENTION

This invention relates to networking. More particularly, the invention relates to a method of power management in a 10GBase-T Ethernet transceiver.

### BACKGROUND

In 10GBase-T (IEEE Std 802.3an) and previous generations of copper Ethernet transceivers for twisted pair media there has been a requirement to support up to 100 m on 4 pair copper media. As part of the initial startup of these links, a mechanism was defined called auto-negotiation. The auto-negotiation process permits the two link partners at each end of a twisted pair link to exchange and identify common operating parameters including speed and data rate so that a valid data link can be established. 10GBASE-T is somewhat different in that it also specifies a low-power operating mode, which only supports 30 m cable lengths that is not included in the auto-negotiation process. It is also common for copper Ethernet transceivers to support multiple speeds.

For reasons of power, it is likely that multiple companies will produce Ethernet transceivers that support copper media up to 30m in length at 10 Gigabit/second. In situations where a cable exceeds 30 m in length, a new method beyond auto-negotiation is required to properly select the operating mode for the link.

Accordingly, there is a need to develop a method of power management in a 10GBase-T Ethernet transceiver that can determine a cable length and assign a low-power mode according when the cable length is determined to be 30-meters or less, and disabling the low-power mode when the cable length is determined to be greater than 30-meters.

### SUMMARY OF THE INVENTION

The current invention provides a method of power management in a 10GBase-T Ethernet transceiver. The method includes determining a cable length from a transmitter to a receiver in the Ethernet. A low-power mode of the transceiver is enabled when the cable length is determined to be 30-meters or less, and the low-power mode of the transceiver is disabled when the cable length is determined to be greater than 30-meters.

In one aspect of the invention, the cable length determination is accomplished using time domain reflectometry.

In another aspect of the invention, the cable length determination can be accomplished prior to an auto-negotiation process, during the auto-negotiation process, or through interrogation of a management interface.

In one embodiment of the invention, the low-power mode is 10GBase-T according to an IEEE 802.3an standard. In one aspect of the current embodiment, the Ethernet transceiver supports at least one low-speed operation mode, where only the 10GBase-T mode is disabled. In a further aspect, the Ethernet transceiver supports only the 10Gbase-T mode, whereby the transceiver is disabled when the distance exceeds the 30-meters, whereas auto-negotiation is enabled to support a lower operational link speed.

In another embodiment of the invention, usage of the Ethernet transceiver is monitored, where an operational link speed is reduced when transmit and receive data is below a predetermined level for a predetermined duration. In one aspect of this embodiment, the transmit and receive data level is less than 10 Gigabits per second. In another aspect of the current embodiment, the transmit and receive duration is exceeds a user defined, programmable threshold. In a further aspect, monitoring the usage is accomplished by monitoring a number of data bytes in the data. In another aspect, monitoring the usage is accomplished by the exchange of status and control information over an unused auxiliary channel as defined in an IEEE 802.3an standard.

### BRIEF DESCRIPTION OF THE FIGURES

The objectives and advantages of the present invention will be understood by reading the following detailed description in conjunction with the drawing, in which:

FIGS. 1-5 show flow diagrams of methods of power management in a 10GBase-T Ethernet transceiver according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

According to the present invention, an Ethernet transceiver can be configured to selectively operate or not operate in the 30 m low-power 10GBase-T mode based on an automatic determination of the attached cable length. For example, time domain reflectrometry can provide a measurement of this cable length. If the attached cable length is 30 m or less, operation in the low power 10GBase-T mode can be enabled. If the attached cable length is greater than 30 m, operation in the low power 10GBase-T mode can be disabled.

10GBASE-T transceivers require large amounts of extremely complex circuitry and as a direct consequence consume large amounts of power, especially when operating with long lengths of copper media. The low power mode was included in the IEEE 802.3an standard because it was widely recognized that there are many situations where there is a need to operate over shorter distances. By creating a distinct low-power mode, which specifies limiting the length of the copper media to 30 m, the power consumption of a 10GBase-T transceiver can be greatly reduced.

According to the current invention, the transceiver will first determine if the cable length exceeds 30-meters. A typical approach to determine the cable length would be to use a technique like Time Domain Reflectometry (TDR) to estimate (determine) the length of the attached cable. This cable length estimation could be accomplished prior to the auto-negotiation process, during the auto-negotiation process, or through interrogation of the management interface. In one embodiment of the invention, once a 10 Gigabit/second Ethernet transceiver designed specifically for 30-meter applications determines that the attached cable is longer than 30 m the 10GBase-T capability is automatically disabled. In one aspect of the invention, for transceivers that only support 10GBase-T operation, the transceiver would effectively be disabled. Alternatively, for transceivers that support one or more lower speeds of operation, only the 10GBase-T mode would be disabled, thus allowing auto-negotiation to a supported lower speed to occur or, if desired, forced operation to a specific selected or supported lower speed.

Because of power considerations it is desirable to drop back in speed even at 30-meters if it is determined that the users are not transmitting or receiving more than a preset or an arbitrarily pre-determined amount of data over a specified period of time. One mechanism to automatically determine link utilization is to monitor the number of 8 bit/10 bit encoding frames being sent and/or received. One advantage here is that this functionality is not required in both link partners. Other methods operating independent of the specific coding used could also be easily extended to serve this function as well including the use of band communications such as the auxiliary bit defined but unused in the IEEE 802.3an. Once the criterion for low utilization has been met, the link speed is reduced to a slower rate, where power consumption is then reduced. According to the current invention, criteria can also be established that triggers an increase in link speed in situations where a higher speed is available and it is previously known that both link partners support the higher speed. With the functionality defined in the this disclosure a 10 Gigabit/second power optimized 30-meter device will have the capability to bring up a link regardless of the cable reach and in situations where the connected cabling is 30 m or less in length the device would further have the capability to automatically adjust the speed and thus the power consumption based on link utilization.

The current invention provides a way to allow power optimized of 30 m 10GBase-T transceivers to automatically select a lower supported operating speed on cables that exceed 30-meters, or to drop back to a lower speed, lower power mode if the traffic being seen is lower than 10 Gigabit/second.

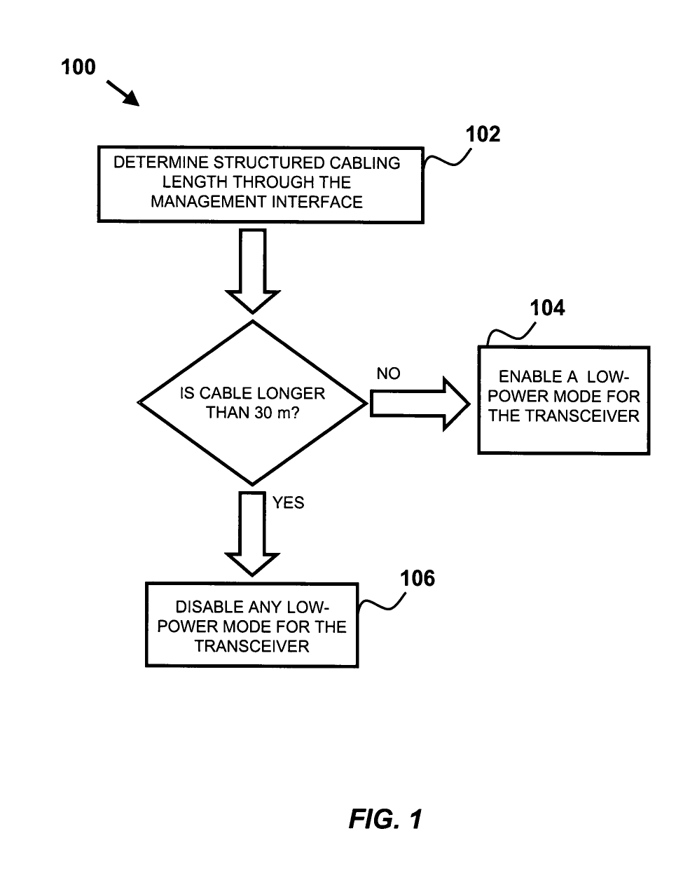

There are several methods available to determine whether a 30 m 10 Gigabit transceiver needs to support a cable longer than 30 m. Referring now to the figures, FIG. 1 shows a flow diagram of a first method of power management 100 in a 10GBase-T Ethernet transceiver according to one embodiment of the present invention. As shown, the method 100 includes determining a cable length from a transmitter to a receiver in the Ethernet 102. A low-power mode of the transceiver is enabled 104 when the cable length is determined to be 30-meters or less, and the low-power mode of the transceiver is disabled 106 when the cable length is determined to be greater than 30-meters.

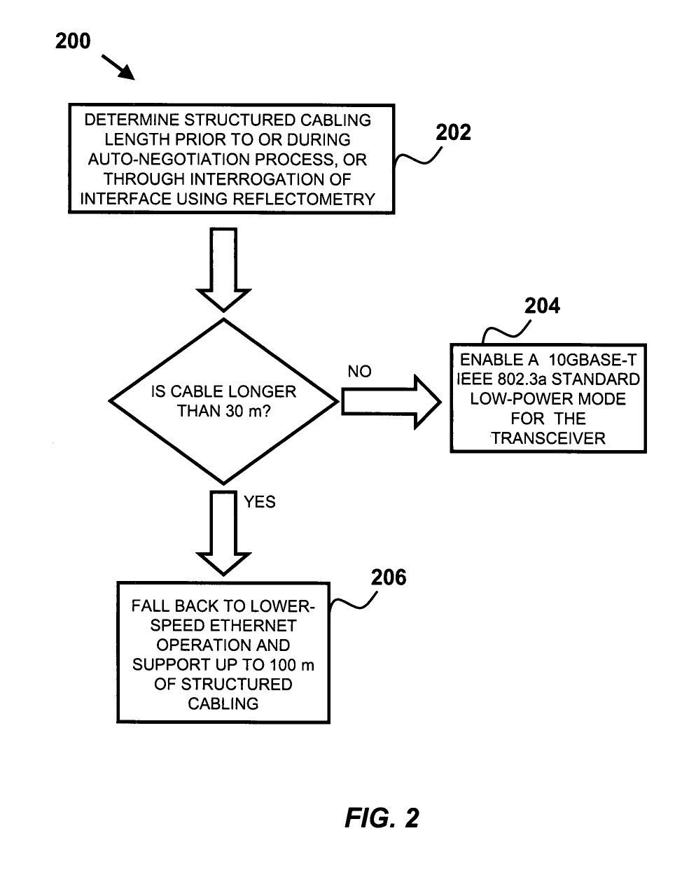

FIG. 2 shows a flow diagram of a second method of power management 200 in a 10GBase-T Ethernet transceiver according to one embodiment of the present invention. As shown, the method 200 includes determining a cable length from a transmitter to a receiver in the Ethernet using time domain reflectometry 202. Here the cable length determination can be accomplished prior to an auto-negotiation process, during the auto-negotiation process, or through interrogation of a management interface. The method 200 further includes using a low-power mode 10GBase-T according to an IEEE 802.3an standard when the cable length is determined to be 30-meters or less 204. According to the current method 200, when the cable length is determined to be more than 30-meters 206, the method 200 falls back to a lower-speed Ethernet operation that supports up to 100-meters of structured cabling.

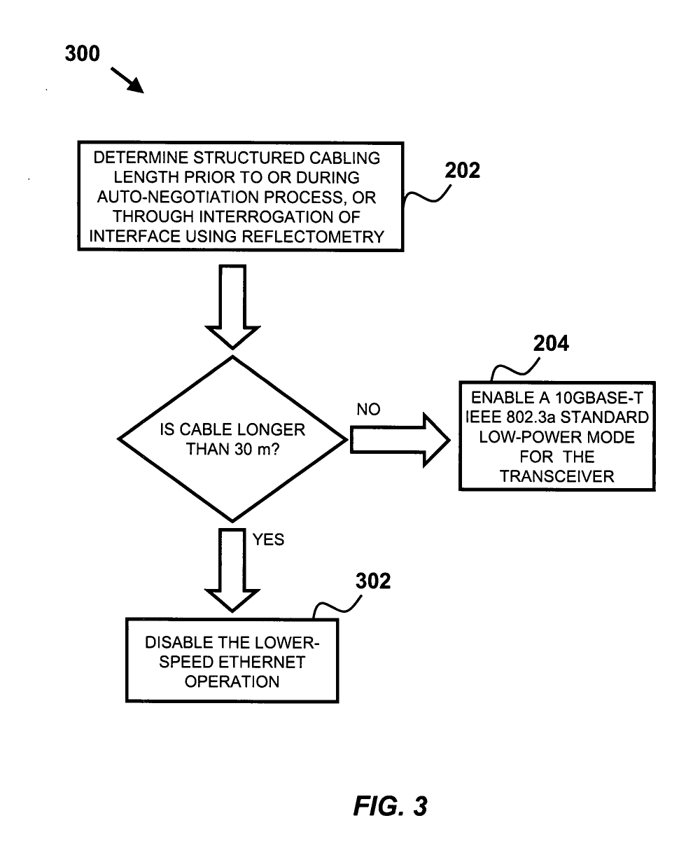

FIG. 3 shows a third embodiment 300 of the method of power management as derived from the methods of FIGS. 1 or 2, where the Ethernet transceiver supports at least one low-speed operation mode, where only the 10GBase-T mode is disabled 302 when it is determined that the cable length is longer than 30-meters. In a further aspect, the Ethernet transceiver supports only the 10Gbase-T mode, whereby the transceiver is disabled 302 when the distance exceeds the 30-meters, whereas auto-negotiation is enabled to support a lower operational link speed.

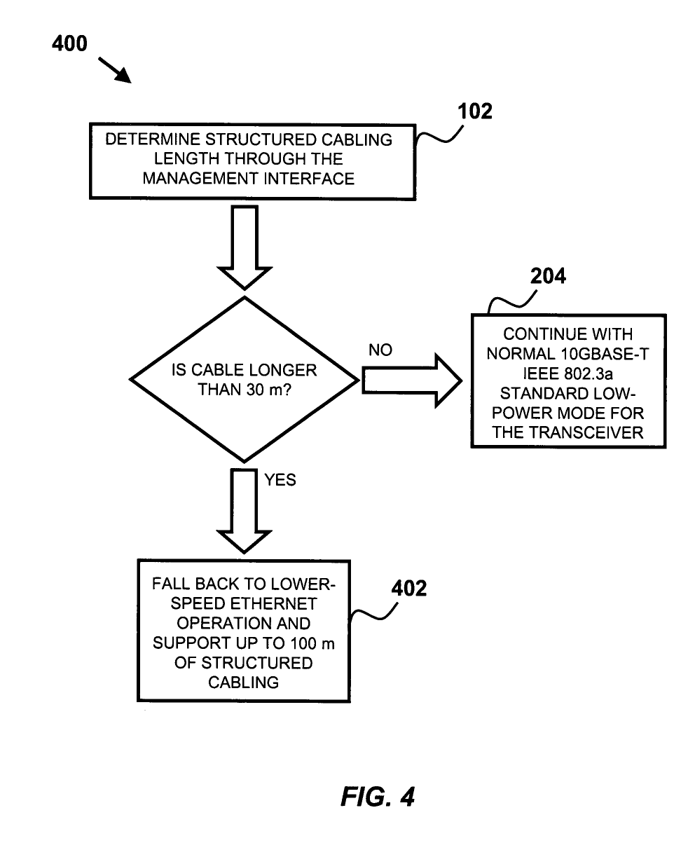

FIG. 4 shows a further embodiment 400 of the method of power management as derived from the methods FIGS. 1 or 2, where the Ethernet transceiver supports at least one low-speed operation mode, where only the 10GBase-T mode is a default 402 mode. When it is determined that the cable length is greater than 30-meters, the method 400 falls back to a lower-speed Ethernet operation and supports up to 100-meters of structured cabling 404.

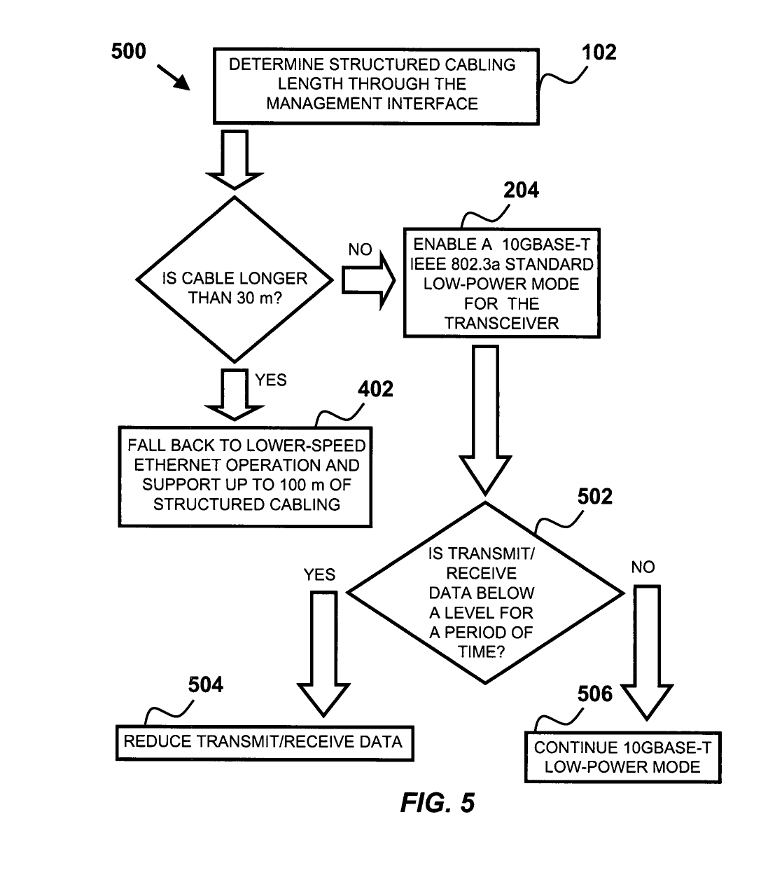

FIG. 5 shows a further embodiment 500 of the method of power management as derived from the methods FIGS. 1, 2, 3, or 4 where the, usage of the Ethernet transceiver is monitored 502. Here, an operational link speed is reduced 504 when transmit and receive data is below a predetermined level for a predetermined duration, or continues with a 10GBase-T operation 506 when the usage is above the predetermined levels. In one aspect of this embodiment, the transmit and receive data level is less than 10 Gigabits per second. In another aspect of the current embodiment, the transmit and receive duration is exceeds a user defined, programmable threshold. In a further aspect, monitoring the usage is accomplished by monitoring a number of data bytes in the data. In another aspect, monitoring the usage is accomplished by the exchange of status and control information over an unused auxiliary channel (not shown) as defined in an IEEE 802.3an standard.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed:

1. A method of power management in a 10GBase-T Ethernet transceiver comprising:
a. determining a cable length from a transmitter to a receiver in said Ethernet;
b. enabling a low-power mode of said transceiver when said cable length is determined to be 30-meters or less; and
c. disabling said low-power mode of said transceiver when said cable length is determined to be greater than 30-meters.

2. The method according to claim 1, wherein said cable length determination is accomplished using time domain reflectometry.

3. The method according to claim 1, wherein said cable length determination is accomplished during a moment selected from a group consisting of prior to an auto-negotiation process, during said auto-negotiation process, and through interrogation of a management interface.

4. The method according to claim 1, wherein said low-power mode is 10GBase-T according to an IEEE 802.3an standard.

5. The method according to claim 4, wherein said Ethernet transceiver supports at least one low-speed operation mode, whereby only said 10GBase-T mode is disabled.

6. The method according to claim 4, wherein said Ethernet transceiver supports only a said 10Gbase-T mode, whereby said transceiver is disabled when said distance exceeds said 30-meters, whereas auto-negotiation is enabled to support a lower operational link speed.

7. The method according to claim 1, wherein usage of said Ethernet transceiver is monitored, whereby operational link speed is reduced when transmit and receive data is below a predetermined level for a predetermined duration.

8. The method according to claim 7, wherein said transmit and receive data level is less than 10 Gigabits per second.

9. The method according to claim 7, wherein said transmit and receive duration is exceeds a user defined, programmable threshold.

10. The method according to claim 7, wherein said monitoring said usage is accomplished by monitoring a number of data bytes in said data.

11. The method according to claim 7, wherein said monitoring said usage is accomplished by the exchange of status and control information over an unused auxiliary channel as defined in an IEEE 802.3an standard.
